(19) United States
(12) Patent Application Publication
(10) Pub. No.: US 2005/0091462 A1
(43) Pub. Date: Apr. 28, 2005

(54) Copy machine for generating or updating an identical memory in redundant computer systems

(75) Inventor: Falk Hoehnel, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Siemens Aktiengesellschaft, Muenchen (DE)

(21) Appl. No.: 10/941,078

(22) Filed: Sep. 15, 2004

(30) Foreign Application Priority Data
Sep. 16, 2003 (GB) 0321566.2

(51) Int. Cl. G06F 12/00

(52) U.S. Cl. 711/162; 711/156

(57) ABSTRACT

A memory architecture and a copy machine is described in which a dirty tag memory is segmented to permit more rapid access to dirty data addresses for subsequent copying.

This invention relates to a copy machine for generating or updating a copy of a computer memory.

Computer users will be familiar with the problems of computers developing run time faults and crashing. Even the most modern of equipment crashes from time to time and in order to avoid the loss of valuable data and stored application programs computer architecture has been developed to hold a duplicate of the memory contents in a memory save area. This is done by the computer continuously copying the contents of the memory into another part of the memory or another memory device.

For some applications, for example, computer servers or telecommunications switches reliability is a crucial issue, so much so, that a parallel system is required of an active unit and a standby unit. The standby unit is constantly updated to be in the same state in terms of memory and system criterion as the active unit in order to take over in the event of the failure of the active unit. When the original active unit fails the standby replicated unit is able to take over with little delay or disruption.

It will be appreciated that the contents of a memory are being constantly changed as a central processing unit CPU continues to operate on tasks on a continual basis. Thus, while a memory copy is made during that copying process the contents of the original memory will have changed. The addresses of the changed bits are termed as “contaminated” or “dirty”. In order to catch these changes, these addresses alone are accessed and the contents copied to the replicated memory. To be able to access the dirty addresses after some time for each dirty address a dedicated “dirty bit” is stored in a so-called dirty tag ram and this bit is set to indicate when the data is “dirty”.

A number of problems exist with this process. A first problem is that of the time required to search for the next dirty bit in the dirty tag ram and to write copies to the replicated memory. A second problem is that the CPU is constantly working. The reading of the tag ram and the writing to the tag ram of new dirty bits will conflict. That is to say, whilst the tag RAM is being read there may be a requirement to perform a write operation. These problems may be further exacerbated by the main memory being split into several sub-memories.

According to the invention there is provided a copy machine for generating or updating a copy of a first computer memory in a second memory; a processor for accessing the first memory and copying at least some of the contents stored therein to the second memory during a copying process; a device for observing the first memory to notice which addresses changed during the copying process; a dirty bit memory for storing in divisions of a first segment indications of which addresses were changed, which dirty bit memory further comprising at least a second segment containing pointers to divisions in the first segment having indications of which addresses were changed.

In the art the indications of the addresses changed during the copying process are termed “dirty bits” but the indications could take different forms such as multiple bits.

The first and the second memory may be within the same unit or distinct units coupled together. In the described embodiment the first memory is located in a first computer system board and the second memory is located in a second computer system board. The boards in the specific embodiment operate as servers in a network. The boards may be provided within one enclosure to form one unit or two enclosures linked together.

By subdividing the dirty bit memory into a first segment having divisions holding dirty bits and providing pointers held in a second segment pointing to the divisions, the accessing of dirty bits is speeded up. To access a dirty bit, the first step is for the dirty bit controller to search the second segment and then to follow the pointer to a division in the first segment. In this way the search for a dirty bit is narrowed to a relevant block of addresses. Thus the controller does not need to search all the bits held in the first segment but it is pointed to a sub-set of those bits.

When the memory is described as being segmented it is important to note that this may refer to an organisational division on one memory or it may reflect a memory made up at the physical level of a number of discrete memory elements such as a number of semiconductor devices configured to provide the memory.

Accordingly, a segment of the memory may be a division of one memory device or alternatively one device of a number forming the memory.

Preferably, the second segment is subdivided and a third segment is provided including pointers to the division s in the second segment which relate to dirty bits in the first segment which have been updated. Then in order to locate a changed dirty bit, a processor accesses the third segment and follows pointers to relevant divisions in the second. The relevant pointers are then followed to the relevant divisions in the first segment.

Further, segments may be provided to, in a similar manner, point to preceding segments from which they depend. In this manner the segments provide a refinement in the search to narrow down the search to particular divisions in the memory where the dirty bit addresses are held. This significantly increases the speed in locating a dirty bit.

Preferably, where the memory is split additional devices to observe the parts of the memory are provided. In a most preferred arrangement, a device to observe is provided to observe each part. In the art the device is often referred to as a “sniffer” or sometimes as a “snooper”. In the specific embodiment, two dirty bit sniffers are provided to observe distinct memories to provide data to be input to a common shared dirty bit memory.

The dirty bit memory is referred to in the art as a dirty tag memory.

A specific embodiment of the invention will now be described by way of example only with reference to and as illustrated by the drawing in which:

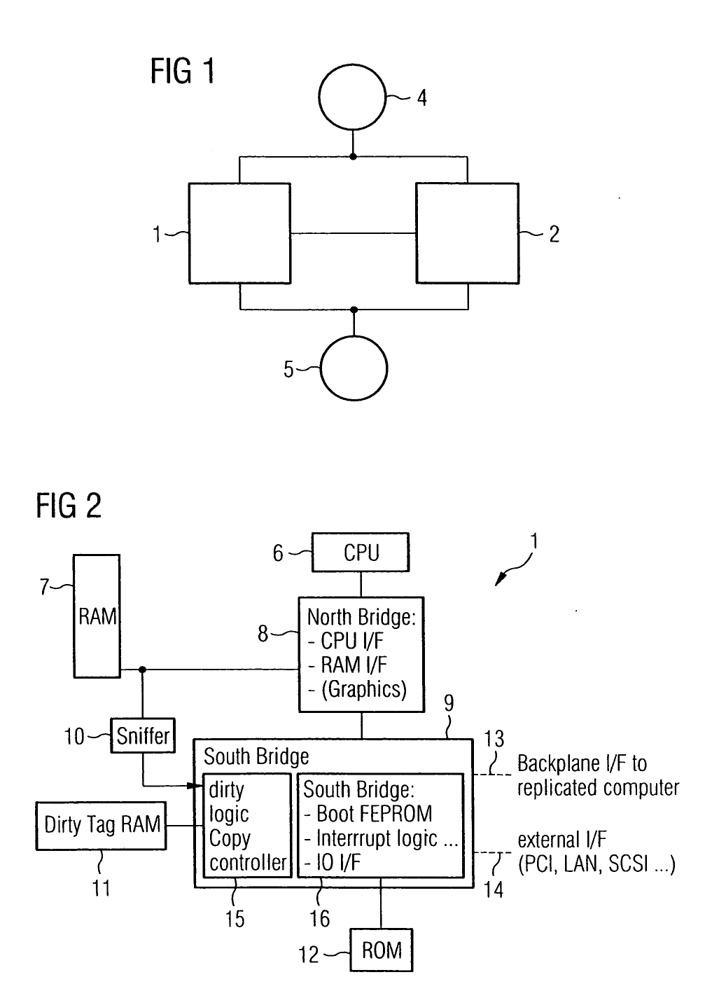

FIG. 1 shows in schematic block diagram form a first computer network server master circuit board 1 connected to a second computer server slave board 2 being a replicated version of the first in accordance with the invention;

FIG. 2 shows in block diagram form the components of the first server shown in FIG. 1;

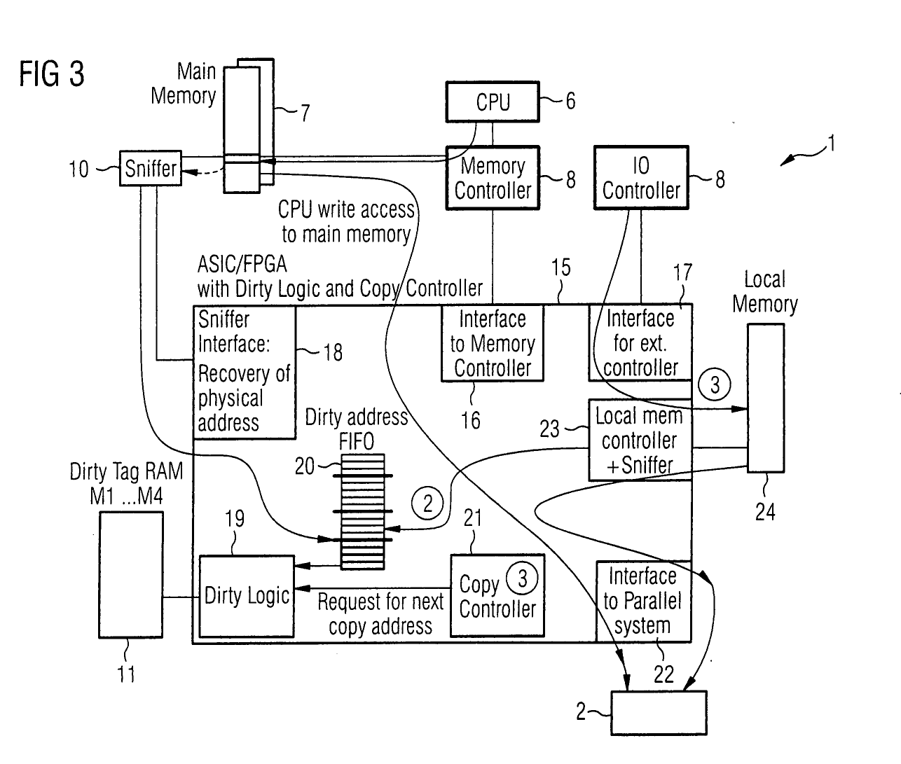

FIG. 3 shows the components of FIG. 2 in greater detail; and

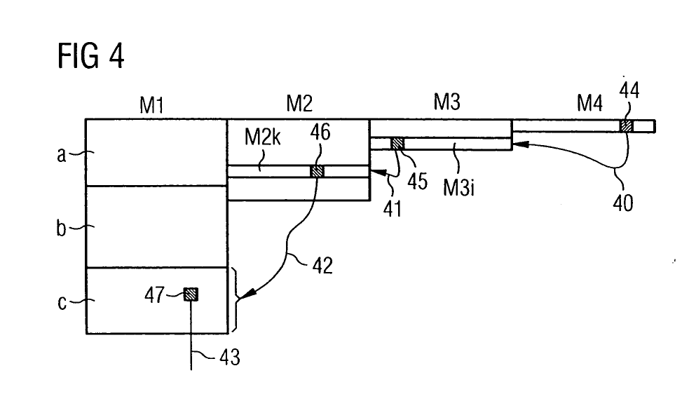

FIG. 4 shows a dirty tag memory structure in accordance with the invention.

A computer network server 1 comprises a master circuit board linked to a back-up, redundancy or replicated computer network server 2 on a slave circuit board by a link 3. Both servers are connected to a local area network 4 and an external network 5. In normal operation the first server 1 operates as a server for the network 4 and replicates itself onto server 2 in a manner to be described later. In the event of a failure of server 1 server 2 takes over its operation. In essence server 1 is active and server 2 a non-active back up ready to take over in the event of a crash.

As is shown in FIG. 2, the server 1 includes a central processor unit (CPU) 6, a Random Access Memory 7, a north bridge 8, a south bridge 9, a dirty bit sniffer 10, a dirty tag RAM 11 and a Read Only Memory (ROM) 12. The south bridge 9 includes a backplane I/F connection 13 and an external I/F connection 14.

The provision of a north and south bridge is well known in the art of computer design. In short, it enables certain functionality to be supported by the different bridges. In the usual case, the north bridge includes the core functionality whilst the south bridge includes functionality which may be updated or refined more frequently than the core. It is then easier to substitute the south bridge for an updated one whether at the factory level or service level than replacing one unit which performs the functionality of both bridges.

The north bridge includes a central processing unit (CPU), a random access memory (RAM), a memory controller and a graphics card (where a display is required).

The south bridge includes the functionality necessary to copy the server 1 to the back-up server 2 and other input/output functionality. It also includes a dirty logic copy controller DLCC 15 and a boot FEPROM, interrupt logic and Input Output I/F functionality 16. The latter functionality will be familiar to a person skilled in the art and therefore not described.

The same architecture is shown in more detail in FIG. 3 with the functional components of the DLCC 15 shown. It is provided as an application specific integrated circuit (ASIC). The components comprise an interface 16 to the memory controller within the north bridge 8; an interface 17 to an input output controller in the north bridge 8; a sniffer interface 18 connected to the sniffer 10; dirty logic 19 coupled to dirty tag RAM 11; a first in first out FIFO dirty address memory 20 coupled to the dirty logic 19 and receiving dirty bit addresses from sniffers 10 and 23; a copy controller 21 for controlling the copying process; an interface 22 coupled to the parallel system embodied in server 2; a local memory controller and sniffer 23 coupled to local memory 24.

As the north bridge operates carrying out the normal functions of the server, the sniffer 10 observes the main memory bus to check whether a memory writing operation is taking place. These are termed dirty addresses and they are sent to the sniffer interface 18 of DLCC 15.

The interface to the memory controller 16 is used by 10 controllers 8 and by copy controller 21 to access main memory 7.

The interface to the external input output controller 17 receives from the input output controller 18 requests for main or local memory access.

The local memory controller 23 writes to and reads the local memory 24. The local memory 24 holds data that is often needed by the IO controller 8. The access to the local memory 24 is much faster than to main memory 7. The sniffer part of this controller sniffs out dirty bits and writes the address to the dirty address FIFO memory 22.

The copy controller 21 writes address and data via the interface 22 to the parallel system 2 to maintain a completely parallel system ready to take over in the event of a failure of the server 1.

The dirty logic 19 provides the functionality to take dirty tag addresses from the FIFO memory 20 and to store a dedicated bit in the dirty tag RAM 11. (It should be noted that the dirty tag addresses from sniffer 10 and also the sniffer functionality of block 23 are used by the dirty logic 19 to populate the same dirty tag RAM 11.) It responds to requests from the copy controller 21 to return the next address of data to be copied to the parallel system.

The sniffer interface 18 receives from the sniffer 10 the physical address of dirty bits and enters them into the dirty address FIFO 20.

The dirty tag RAM 11 is shown in greater detail in FIG. 4. It will be seen that the RAM is split into segments M 1 to M4. Each of the segments M1 to M3 is split into divisions. M4 is not divided. In the case of M1 there are three divisions a to c. M1 includes the dirty bits. M2 includes a pointer to relevant division a to c of M1. M3 has pointers to divisions in M2.

The RAM 11 is utilised in a first step to access M4. This returns a pointer 40 to a division M3. This in turn returns a pointer 41 to a division of M2. In turn, this division returns a pointer 42 to the division c of M1 which is to be searched for the next dirty bit 43. From this dirty bit the dirty main memory address in memory 7 can be determined to copy this address to the parallel system again.

It will be appreciated that there will three operation types involving this memory. A write operation in which the dirty bit is written, an access operation in which the address is retrieved and a clear down operation when the tag memory is to be cleared for a particular address.

In the write operation, the dirty logic 23 takes the dirty bit address from the FIFO memory 22 and writes it into one of the divisions a to c. The dirty logic 23 determines an appropriate location in part M2 for a pointer. At that location the start address of the division c is stored. Similarly, an entry in M3 is made with the start address of the relevant division of M2 and similarly in M4 for M3.

Consider a specific example of a dirty memory of 100,000 bits. M1 is organised as 10000×10 bit and divided in 1000 virtual segments. So M2 has to be as large as 1000 bits. When bit number 937 is set then in M1 the segment number 937 has to be checked for dirty bits.

M2 is organised as 100×10 bit. So M3 has to be 100 bits large and will have bit number 93 as dirty. M3 is organised as 10×10. So M4 has to hold 10 bit only with bit 9 is set. When the copy controller 21 wants to determine the next address, it has to look at M4, and easily finds bit 9 dirty. Then it looks directly to the 9^{th} row of M3 and finds bit 93 dirty. This points to row 93 of M2 and bit 937 is found dirty. Now the segment 938 with 10 rows of 10 bits has to be read to find the real dirty bit and to determine the wanted dirty address.

For the dirty logic 19 to return an address it access the dirty tag RAM 11 at memory part M4. It finds entry 44 and determines therefrom the start address of division M3i. The logic finds entry 45 in the division and derives therefrom the start of the division m2k. Searching in the memory locations, the logic finds an entry 46 the contents of which are used to determine the start address of division c of M1. The dirty logic 19 then finds within the division c the entry 47 that contains the next bit to determine the next copy address.

The clear down process is carried out in the following manner. When bit 47 is cleared, in the same segment further bits could be dirty. Accordingly, not until the last dirty bit of this segment is cleared, is the appropriate bit 46 in M3 is allowed to be cleared. The same applies for clearing bits in M3, M2, M1.

Having explained the detailed operation of the dirty logic and copy controller 13, the way in which the memory is replicated will now be explained.

At a point in time at the start of the replication process, the current memory is copied to the replicated server 2. During this process the sniffer 10 monitors the memory 7 for any writing operations which contaminate the data in the memory being copied. These are termed dirty data and the addresses are passed via the sniffer interface 18 to the dirty address FIFO memory 20. The use of a FIFO memory avoids contention between dirty bit searches and dirty bit setting.

Having created a backup copy of the current main memory, a first stage in the process is completed. In a second stage the copy is revised to take into account the dirty bits that is to say the data that was changed during the replication. In this process, the dirty addresses are obtained by the use of the dirty logic and copy controller 15 as described above. The copy controller 21 acts by obtaining the dirty data addresses and copying the contents to the copy of the memory held in the backup memory partition via the interface 20. The address information ensures that the information is copied to the local or the main memory in the server 2.

In alternative embodiments of the invention the number of the divisions in the dirty tag memory may be more or fewer than the described embodiment. The number of divisions may be predetermined during configuration of the system or it may be varied during operation. Whilst in the above-described embodiment the replicated system is located on a distinct slave board it could be incorporated into the first. In some embodiments the original memory and the memory to which a copy of the first is written could be embodied as one memory. This could be considered as two memory divisions in the same memory.

1. A copy machine for generating or updating a copy of at least a first computer memory in at least a second memory; a processor for accessing the first memory and copying at least some of the contents stored therein to the second memory during a copying process; an observing device for observing the first memory to notice which memory addresses had contents changed during the copying process ;a dirty bit memory for storing in divisions of a first segment indications of which addresses were changed, which dirty bit memory further comprising at least a second segment containing pointers to divisions in the first segment having indications of which addresses were changed.

2. A machine as claimed in claim 1 wherein the machine copies data from more than one first memories into more than one second memories.

3. A machine as claimed in claim 2 wherein the machine copies data from more than one first memories into a corresponding number of second memories.

4. A machine as claimed in claims 2 or 3 wherein each of the first memories is observed by an observing device.

5. A machine as claimed in any preceding claim including an address memory for storing addresses the contents of which are observed by the observing devices as being updated during the copying process and logic means to access the address memory and to derive therefrom indications to be stored in the dirty bit memory.

6. A machine as claimed in claim 5 wherein the address memory is a first in first out memory.

7. A machine as claimed in any preceding claim wherein the or each observing device is a dirty bit sniffer.

8. A machine as claimed in any preceding claim wherein the dirty bit memory is a dirty tag memory.

9. A machine as claimed in claim any preceding claim wherein the more than one first memory is a main memory and a local memory.

10. A machine as claimed in claim 8 wherein the main memory is observed by a first sniffer and the local memory by a second sniffer.

11. A copy machine substantially as hereinbefore described with reference to and as illustrated by the drawing.

12. A computer including a copy machine as claimed in any preceding claim.

13. A communications server including a copy machine as claimed in any preceding claim.
